(19) United States
(12) Patent Application Publication
(10) Pub. No.: US 2026/0141916 A1
(43) Pub. Date: May 21, 2026

(54) DATA AUGMENTATION METHOD, RESPIRATORY SOUND CLASSIFICATION METHOD, AND ELECTRONIC DEVICE

(71) Applicants: National Tsing Hua University, Hsinchu (TW); NATIONAL TAIWAN UNIVERSITY HOSPITAL HSIN-CHU BRANCH, Zhubei (TW); NATIONAL TAIWAN UNIVERSITY, Taipei (TW)

(72) Inventors: AN-YAN CHANG, Hsinchu (TW); JING-TONG TZENG, Hsinchu (TW); CHI-CHUN LEE, Hsinchu (TW); PEI-CHUAN HUANG, Zhubei (TW)

(21) Appl. No.: 19/174,669

(22) Filed: Apr. 9, 2025

(30) Foreign Application Priority Data
Nov. 15, 2024 (TW) 113144170

(51) Int. Cl. G10L 25/66; G10L 21/10; G10L 25/30

(52) U.S. Cl. CPC G10L 25/66; G10L 21/10; G10L 25/30

(57) ABSTRACT

The instant disclosure provides a data augmentation method for expanding a dataset. The dataset includes a plurality of spectrograms. The data augmentation method includes: selecting at least one patch within a first spectrogram of the plurality of spectrograms; determining at least one adjustment value corresponding to the at least one patch within the first spectrogram; and adjusting the at least one patch within the first spectrogram, based on the at least one adjustment value, to obtain a first adjusted spectrogram, where the at least one adjustment value includes at least one of a contrast adjustment value, a brightness adjustment value, and a gamma adjustment value.

### CROSS-REFERENCE TO RELATED APPLICATION(S)

The present application claims the benefit of and priority to Taiwan Patent Application Serial No. 113144170, filed on Nov. 15, 2024, entitled “DATA AUGMENTATION METHOD, RESPIRATORY SOUND CLASSIFICATION METHOD AND ELECTRONIC DEVICE”, the contents of which are hereby incorporated herein fully by reference into the present application for all purposes.

### FIELD

The present disclosure generally relates to a machine learning technology, and more particularly, to a data augmentation method, a respiratory sound classification method, and an electronic device.

### BACKGROUND

With the rise of artificial intelligence, medical platforms or systems for respiratory sound classification may support functions such as respiratory sound classification. Existing respiratory sound classification technologies perform well in identifying normal respiratory sounds, but the ability for detecting abnormal respiratory sounds still needs improvement. A possible reason for this is the insufficient number of abnormal respiratory sound samples in existing speech datasets, which prevents the system from adequately learning and improving performance.

To address the issue of insufficient sample size, methods such as SpecAugment may be used for data augmentation on respiratory sound data. However, the SpecAugment method mentioned above tends to excessively mask the spectrogram, which may result in the masking of high-frequency or low-frequency features associated with abnormal respiratory sounds. Therefore, the problem that needs to be solved is how to perform effective data augmentation while preserving the characteristics of abnormal respiratory sounds, ultimately improving the classification results of abnormal respiratory sounds.

### SUMMARY

In view of the above, the present disclosure provides a data augmentation method, a respiratory sound classification method, and an electronic device. By adjusting and partially masking multiple patches in the spectrogram, the method addresses the issue of limited respiratory sound data while preserving the features of the abnormal respiratory sounds, thus enhancing the neural network's accuracy in distinguishing abnormal respiratory sounds.

According to a first aspect of the present disclosure, a data augmentation method for expanding a dataset is provided. The dataset including a plurality of spectrograms. The data augmentation method including: selecting at least one patch within a first spectrogram of the plurality of spectrograms; determining at least one adjustment value corresponding to the at least one patch within the first spectrogram; and adjusting the at least one patch within the first spectrogram based on the at least one adjustment value, to obtain a first adjusted spectrogram, where the at least one adjustment value comprises at least one of a contrast adjustment value, a brightness adjustment value, and a gamma adjustment value.

In an implementation of the first aspect of the present disclosure, determining the at least one adjustment value corresponding to the at least one patch includes determining the at least one adjustment value within a predefined range for each of the at least one patch.

In another implementation of the first aspect of the present disclosure, determining the at least one adjustment value within the predefined range for each of the at least one patch includes determining a gamma adjustment value within the predefined range, and a minimum value of the gamma adjustment value is greater than or equal to 1.

In another implementation of the first aspect of the present disclosure, the data augmentation method further including synthesizing the first adjusted spectrogram and a second spectrogram in the dataset, based on a synthesis ratio, to obtain a synthesized spectrogram.

In another implementation of the first aspect of the present disclosure, both of the first spectrogram and the first adjusted spectrogram correspond to a first label, the second spectrogram corresponds to a second label, and the data augmentation method further includes determining a third label corresponding to the synthesized spectrogram based on the first label, the second label, and the synthesis ratio.

In another implementation of the first aspect of the present disclosure, a width of each of the at least one patch is smaller than a width of the first spectrogram.

In another implementation of the first aspect of the present disclosure, each of the plurality of spectrograms comprises a Mel spectrogram.

According to a second aspect of the present disclosure, a respiratory sound classification method is provided. The respiratory sound classification method including acquiring a respiratory sound; and classifying the respiratory sound into one of a plurality of respiratory sound categories based on a machine learning model, wherein the machine learning model is trained based on a dataset, and the dataset is expanded based on the data augmentation method from the first aspect of the present disclosure.

In an implementation of the second aspect of the present disclosure, the respiratory sound categories include a crackle category and a wheeze category.

In an implementation of the second aspect of the present disclosure, the machine learning model comprises a convolutional neural network (CNN) model.

According to a third aspect of the present disclosure, an electronic device is provided. The electronic device includes a memory storing at least one computer-executable instruction; and a processor coupled to the memory and configured to execute the at least one computer-executable instruction to perform the data augmentation method from the first aspect of the present disclosure.

### BRIEF DESCRIPTION OF THE DRAWINGS

This patent or application file contains at least one drawing executed in color. Copies of this patent or patent application publication with color drawing(s) will be provided by the Office upon request and payment of the necessary fee. The present disclosure will be better understood from the following detailed description read in light of the accompanying drawings, where:

FIG. 1 is a flowchart illustrating a data augmentation method according to an example implementation of the present disclosure.

FIG. 2 is a schematic diagram illustrating a data augmentation method according to an example implementation of the present disclosure.

FIG. 3 is a flowchart illustrating a respiratory sound classification method according to an example implementation of the present disclosure.

FIG. 4A is a first spectrogram according to an example implementation of the present disclosure.

FIG. 4B illustrates an overlay of a first heatmap and a first spectrogram according to an example implementation of the present disclosure.

FIG. 4C illustrates an overlay of a second heatmap and a first spectrogram according to an example implementation of the present disclosure.

FIG. 5A is a second spectrogram according to an example implementation of the present disclosure.

FIG. 5B illustrates an overlay of a third heatmap and a second spectrogram according to an example implementation of the present disclosure.

FIG. 5C illustrates an overlay of a fourth heatmap and a second spectrogram according to an example implementation of the present disclosure.

FIG. 6A is a third spectrogram according to an example implementation of the present disclosure.

FIG. 6B illustrates an overlay of a fifth heatmap and a third spectrogram according to an example implementation of the present disclosure.

FIG. 6C illustrates an overlay of a sixth heatmap and a third spectrogram according to an example implementation of the present disclosure.

FIG. 7 is a block diagram of a computing system according to an example implementation of the present disclosure.

### DETAILED DESCRIPTION

The detailed description provided below in connection with the appended drawings is intended as a description of the present examples and is not intended to represent the only forms in which the present examples may be constructed or utilized. The description sets forth the functions of the examples and the sequence of steps for constructing and operating the examples. However, the same or equivalent functions and sequences may be accomplished by different examples.

For convenience, certain terms employed in the specification, examples, and appended claims are collected here. Unless otherwise defined herein, scientific, and technical terminologies employed in the present disclosure shall have the meanings that are commonly understood and used by one of ordinary skill in the art. Also, unless otherwise required by context, it will be understood that singular terms shall include plural forms of the same, and plural terms shall include the singular. Specifically, as used herein and in the claims, the singular forms “a” and “an” include the plural reference unless the context clearly indicates otherwise. Also, as used herein and in the claims, the terms “at least one” and “one or more” have the same meaning and include one, two, three, or more.

Terms such as “at least one embodiment”, “one embodiment”, “multiple embodiments”, “different embodiments”, “some embodiments”, “present embodiment”, and the like may indicate that an embodiment of the present disclosure so described may include a particular feature, structure, or characteristic, but not every possible embodiment of the present disclosure must include a particular feature, structure, or characteristic. Furthermore, repeated use of the phrases “in one embodiment”, “in the embodiment”, and so on does not necessarily refer to the same embodiment, although they may be identical. Furthermore, the use of phrases such as “embodiments” in connection with “the present disclosure” does not imply that all embodiments of the present disclosure necessarily include a particular feature, structure, or characteristic, and should be understood as “at least some embodiments of the present disclosure” include the particular feature, structure, or characteristic described.

Additionally, for the purposes of explanation and non-limitation, specific details such as functional entities, techniques, protocols, standards, and the like are set forth for providing an understanding of the described technology. In other examples, detailed disclosure of well-known methods, technologies, systems, architectures, and the like are omitted so as not to obscure the disclosure with unnecessary details.

The terms “first”, “second”, and “third” in the description of the present disclosure and the above-mentioned drawings are used to distinguish different objects, rather than to describe a specific order.

Furthermore, the term “comprising” and any variations thereof are intended to cover non-exclusive inclusions and may refer to “including but not necessarily limited to”, which specifically indicates open-ended inclusion or membership in the so-described combination, group, series, and the equivalent. For example, a process, method, system, product, or device that includes a series of steps or modules is not limited to the listed steps or modules, but optionally also includes steps or modules that are not listed, or optionally also includes other steps or modules that are inherent to those processes, methods, products, or devices.

Methods for expanding speech datasets include, for example, SpecAugment (SpecAug). The SpecAug data augmentation method excessively masks the spectrogram, such as by horizontally masking all information within a specific frequency range. However, horizontally masking all information within a specific frequency range may mask out the high-frequency or low-frequency regions of the spectrogram, which may contain critical acoustic features of abnormal respiratory sounds.

Specifically, abnormal respiratory sounds include crackles and wheezes. The features of crackles in the spectrogram include, for example, each explosive and discontinuous sound having a short duration (within 20 milliseconds) and a frequency range of 350 Hz to 650 Hz. The features of wheezes in the spectrogram include, for example, each wheeze having a duration of over 100 milliseconds and a frequency range between 100 Hz and 5000 Hz.

Therefore, using the SpecAug method may mask our the high-frequency or low-frequency regions of the spectrogram that contain critical acoustic features of abnormal respiratory sounds, thus misleading the model's ability to detect abnormal respiratory sounds during training.

Accordingly, there is a need for a data augmentation method suitable for respiratory sound classification that may achieve effective data augmentation while preserving the features of abnormal respiratory sounds. In this manner, when the dataset obtained by the above method is used to train the model, the model's performance in classifying abnormal respiratory sounds may be improved.

The implementations of the present disclosure are described below with reference to the accompanying drawings.

### <<Data Augmentation Method>>

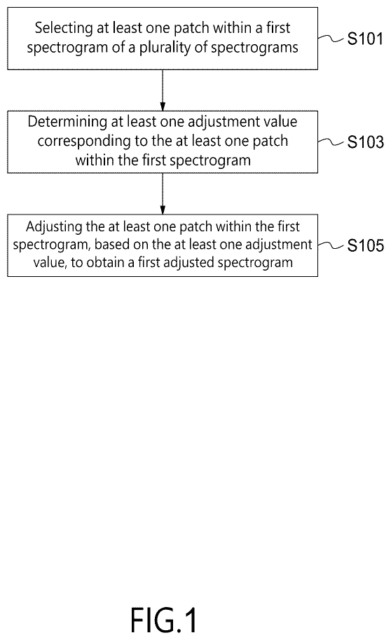

FIG. 1 is a flowchart illustrating a data augmentation method according to an example implementation of the present disclosure. A data augmentation method may be executed by an electronic device, where the electronic device includes a processor. Details regarding the electronic device will be described in subsequent paragraphs.

Referring to FIG. 1. In step S101, selecting at least one patch in a first spectrogram of a plurality of spectrograms.

Specifically, the plurality of spectrograms may represent all or a portion of the spectrograms within a dataset, and the first spectrogram may be one of the plurality of spectrograms. For example, the dataset including the plurality of spectrograms may be a publicly available dataset, such as the dataset provided by the 2017 International Conference on Biomedical and Health Informatics (ICBHI). Alternatively, the dataset including the plurality of spectrograms may also be derived from another dataset that includes a plurality of respiratory sounds.

Specifically, a processor may arbitrarily select the at least one patch within the first spectrogram, where the selected patches may have the same or different sizes.

In some implementations, the processor may select the first spectrogram from the plurality of spectrograms in the dataset.

In some implementations, the processor may arbitrarily select at least one patch from each of the plurality of spectrograms in the dataset, where the sizes of the patches may be the same or different.

In some implementations, the spectrograms include Mel spectrograms.

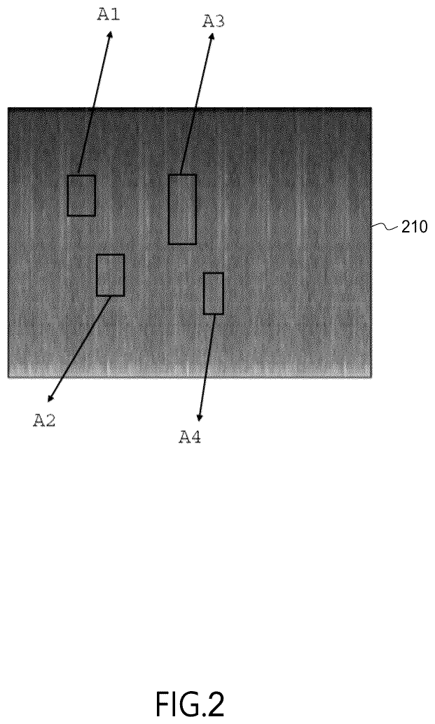

FIG. 2 is a schematic diagram illustrating a data augmentation method according to an example implementation of the present disclosure.

Please refer to FIG. 2. Specifically, the processor may randomly select at least one patch from the entire area of the spectrogram 210, where the spectrogram 210 may represent the first spectrogram. For example, the processor may randomly select four patches from the entire area of the spectrogram 210, including patch A1, patch A2, patch A3, and patch A4. For example, patch A1 and patch A2 may have the same size, while patch A1, patch A3, and patch A4 may have different sizes.

Please refer to FIG. 1. In some implementations, the processor may select up to 32 patches from the first spectrogram, where the size of each patch may be entirely different, partially different, or entirely the same. Specifically, each of the 32 patches may have a different size, or the 32 patches may include some patches of the same size and some patches of different sizes.

In some implementations, a width of each of the at least one patch is less than a width of the first spectrogram, and a length of each of the at least one patch is less than a length of the first spectrogram. In some implementations, a size of each patch does not exceed 256 spectrogram units (pixels). When the size of a patch does not exceed 256 spectrogram units, which is no more than 0.4% of a total size of the spectrogram, it may prevent interference with large-scale features in the spectrogram. For example, when the patch is too large, it may cover high-frequency or low-frequency areas in the spectrogram that include key acoustic features of abnormal breath sounds or affect the classification of an entire breathing cycle.

Please refer to FIG. 1. In step S103, determining at least one adjustment value corresponding to the at least one patch within the first spectrogram.

Specifically, the processor will use each of the patches previously selected from the first spectrogram as an object for determining an adjustment value. The adjustment value includes at least one of a contrast adjustment value, a brightness adjustment value, and a gamma adjustment value.

Please refer to FIG. 2. For example, the processor may determine a corresponding adjustment value for each of the patches A1, A2, A3, and A4.

In some implementations, the processor may determine that adjustment values for each of the patch A1, patch A2, patch A3, and patch A4 are all gamma adjustment values. In other words, the processor may decide the adjustment values for each patch in the first spectrogram, where the adjustment values for each patch may be the same. Furthermore, taking patch A1 as an example, the processor may determine the adjustment values for each pixel within patch A1 based on the adjustment value corresponding to patch A1. In such example, the adjustment values for the pixels within patch A1 are the same as the adjustment value corresponding to patch A1.

In some implementations, the processor may determine that the adjustment values for patch A1, patch A3, and patch A4 are gamma adjustment values. Additionally, the processor may determine that the adjustment value for patch A2 is a contrast adjustment value. In other words, the processor may determine an adjustment value for each patch in the first spectrogram, where the adjustment value for each patch in the first spectrogram may not be entirely the same.

Please referring to FIG. 1. In some implementations, the processor may determine an adjustment value for each selected patch within a predefined range. Specifically, the processor may determine (e.g., randomly determine) an adjustment value for each patch within the predetermined range.

In some implementations, when the processor determines to use gamma adjustment values to adjust each patch, the processor may determine the gamma adjustment value within a predefined range, where the minimum value of the gamma adjustment value is greater than or equal to 1.

In some implementations, when the processor determines to use gamma adjustment values to adjust each patch, the processor may determine the gamma adjustment value within a predefined range of 1.7 to 2.0.

Please refer to FIG. 2. In some implementations, for example, when the processor selects to use gamma adjustment values to adjust patch A1, patch A2, patch A3, and patch A4, the processor may determine that the gamma adjustment value for each patch is greater than or equal to 1, where the gamma adjustment values for each patch may be entirely the same or may partially different.

In some implementations, for example, the processor may determine that the gamma adjustment values for patch A1, patch A2, patch A3, and patch A4 are all 1.5. In other words, the processor may determine that the gamma adjustment values for each patch are entirely the same. Furthermore, taking patch A1 as an example, when the gamma adjustment value is 1.5, the processor may determine that the gamma adjustment value for each pixel in patch A1 is based on the gamma adjustment value corresponding to patch A1. Specifically, the gamma adjustment value for each pixel in patch A1 is the same as the gamma adjustment value corresponding to patch A1, which is 1.5.

In some implementations, for example, the processor may determine that the gamma adjustment value for patch A1 is 1.0, the gamma adjustment value for patch A2 is 1.2, the gamma adjustment value for patch A3 is 1.4, and the gamma adjustment value for patch A4 is 1.3. In other words, the processor may determine that the gamma adjustment values for these patches are entirely different.

In some implementations, for example, the processor may determine the gamma adjustment value for patch A1 is 1.0, for patch A2 is 2.0, and for both patch A3 and patch A4 are 1.3. In other words, the processor may determine that the gamma adjustment values for these patches are partially the same and partially different.

Please continue to refer to FIG. 1. In step S105, adjusting the at least one patch of the first spectrogram, based on the at least one adjustment value, to obtain a first adjusted spectrogram.

Specifically, the processor may adjust each patch of the at least one patch in the first spectrogram according to the adjustment value corresponding to that patch. The adjustment value includes at least one of a contrast adjustment value, a brightness adjustment value, or a gamma adjustment value. Furthermore, the processor may adjust at least one of the contrast or brightness of each pixel within the patch based on the adjustment value. Upon the processor adjusts the first spectrogram according to the adjustment value corresponding to each patch, the processor generates the first adjusted spectrogram.

Please refer to FIG. 2. For example, in some embodiments, the processor may determine that the adjustment values for patch A1, patch A2, patch A3, and patch A4 in the spectrogram 210 are gamma adjustment values. The processor may perform gamma correction on each patch based on the respective gamma adjustment value. In some implementations, the processor may determine the gamma adjustment values for patch A1, patch A2, patch A3, and patch A4 are 1.0, 2.0, 1.3, and 1.4, respectively.

Taking patch A2 as an example, when the gamma adjustment value of patch A2 is 2.0, the processor could obtain a relationship curve with a gamma adjustment value of 2.0 based on the input-output relationship for gamma correction. The processor could map and adjust each pixel value in patch A2, according to the relationship curve with a gamma adjustment value of 2.0, to complete the image correction of patch A2. Similarly, the processor may adjust each pixel value in patch A1, patch A2, patch A3, and patch A4, based on the respective gamma adjustment values of each patch, ultimately resulting in the adjusted spectrogram.

In some implementations, for example, when the processor adjusts each patch within a Mel spectrogram using gamma adjustment values within a predetermined range of 1.7 to 2.0, strong signals in the Mel spectrogram may be emphasized while weak signals are suppressed. The strong and weak signals in the Mel spectrogram are determined by a magnitude of the feature values within the spectrogram. By adjusting the gamma adjustment values within the predefined range of 1.7 to 2.0, the features of the respiratory cycle in the spectrogram are highlighted, and noise is suppressed, which helps the machine learning model learn the features of the respiratory cycle in the spectrogram.

In some implementations, the processor may augment the dataset based on the first adjusted spectrogram. For example, the processor may add the first spectrogram to the dataset, making the first spectrogram become one of the data within the dataset.

In some implementations, the processor will associate the first adjusted spectrogram with a label corresponding to the first spectrogram. For example, in the dataset, a label corresponding to the first adjusted spectrogram is the same as the label corresponding to the first spectrogram. For example, when the first spectrogram corresponds to a crackle sound, the first adjusted spectrogram will also correspond to a crackle sound.

In some implementations, for the aforementioned dataset, the processor may further perform a Mixup data augmentation. Specifically, after obtaining the first adjusted spectrogram, the processor may synthesize the first adjusted spectrogram with a second spectrogram from the dataset, based on a synthesis ratio, to obtain a synthesized spectrogram. Specifically, the processor may randomly select the second spectrogram from the dataset. For example, the second spectrogram may be a spectrogram different from the first adjusted spectrogram, among the plurality of spectrograms in the dataset.

In some implementations, the processor may determine a synthesis ratio of the first adjusted spectrogram and a synthesis ratio of the second spectrogram. Then, the processor will synthesize the first adjusted spectrogram and the second spectrogram, based on the synthesis ratio of the first adjusted spectrogram and the synthesis ratio of the second spectrogram, to obtain the synthesized spectrogram.

In some implementations, for example, the second spectrogram is the adjusted spectrogram obtained through steps S101, S103, and S105.

In some implementations, the synthesis ratio mentioned above is less than or equal to 1. For example, if the processor determines that the synthesis ratio of the first adjusted spectrogram is 0.7, the processor may determine that the synthesis ratio of the second spectrogram is 0.3. For instance, the processor calculates the weighted average of the pixel values of the first adjusted spectrogram and the pixel values of the second spectrogram using weights of 0.7 and 0.3, respectively, to obtain the synthesized spectrogram corresponding to the first adjusted spectrogram and the second spectrogram. Alternatively, the processor may set an opacity of the first adjusted spectrogram and an opacity of the second spectrogram to 0.7 and 0.3, respectively, and overlay the first adjusted spectrogram and second spectrogram with the set opacities, to obtain the synthesized spectrogram. In another implementations, the processor may set a transparency of the first adjusted spectrogram and a transparency of the second spectrogram to 0.3 and 0.7, respectively, and overlay the first adjusted spectrogram and second spectrogram with the set transparencies, to obtain the synthesized spectrogram.

In some implementations, the synthesis ratio mentioned above is less than or equal to 1. For example, if the processor determines that the synthesis ratio of the first adjusted spectrogram is 0.4, the processor may determine that the synthesis ratio of the second spectrogram is 0.6. For instance, the processor calculates the weighted average of the pixel values of the first adjusted spectrogram and the pixel values of the second spectrogram using weights of 0.4 and 0.6, respectively, to obtain the synthesized spectrogram corresponding to the first adjusted spectrogram and the second spectrogram. Alternatively, the processor may set the opacity of the first adjusted spectrogram and the opacity of the second spectrogram to 0.4 and 0.6, respectively, and overlay the first adjusted spectrogram and second spectrogram with the set opacities, to obtain the synthesized spectrogram. In another implementations, the processor may set the transparency of the first adjusted spectrogram and the transparency of the second spectrogram to 0.4 and 0.6, respectively, and overlay the first adjusted spectrogram and second spectrogram with the set transparencies, to obtain the synthesized spectrogram.

In some implementations, both the first spectrogram and the first adjusted spectrogram correspond to a first label, while the second spectrogram corresponds to a second label. The processor may determine a third label corresponding to the synthesized spectrogram based on the first label, the second label, and the synthesis ratio. For example, when the first adjusted spectrogram corresponds to the first synthesis ratio and the second spectrogram corresponds to the second synthesis ratio, the processor may use the first synthesis ratio and second synthesis ratio as respective weights for the first label and second label. The processor may then compute a weighted average of the first label and second label to derive the third label.

For example, a spectrogram corresponding to crackle sounds may correspond to the label [0, 1, 0, 0], a spectrogram corresponding to wheeze sounds may correspond to the label [0, 0, 0, 1], a spectrogram corresponding to both crackle and wheeze sounds may correspond to the label [1, 0, 0, 0], and a spectrogram corresponding to normal breathing sounds (e.g., neither crackle nor wheeze) may correspond to the label [0, 0, 1, 0]. When the first adjusted spectrogram corresponds to the first label [0, 1, 0, 0], the second spectrogram corresponds to the second label [0, 0, 0, 1], and the synthesis ratios are [0.7, 0.3], the synthesized spectrogram corresponds to the third label [0, 0.7, 0, 0.3]. Similarly, when the first adjusted spectrogram corresponds to the first label [0, 1, 0, 0], the second spectrogram corresponds to the second label [0, 0, 0, 1], and the synthesis ratios are [0.4, 0.6], the synthesized spectrogram corresponds to the third label [0, 0.4, 0, 0.6].

In some implementations, the processor may augment the dataset based on the synthesized spectrogram. For example, the processor may add the synthesized spectrogram to the dataset, making the synthesized spectrogram becomes a data in the dataset and corresponds to a third label.

### <<A Respiratory Sound Classification Method>>

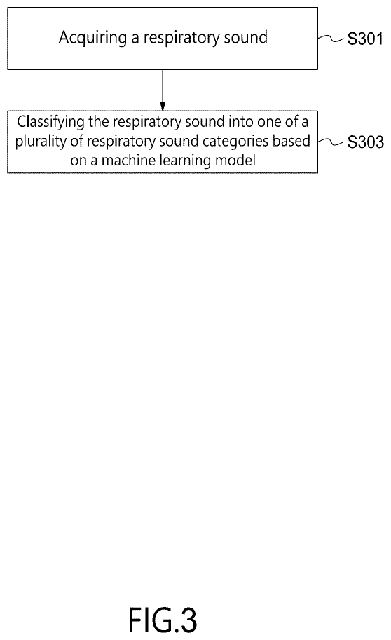

FIG. 3 is a flowchart illustrating a respiratory sound classification method according to an example implementation of the present disclosure. A respiratory sound classification method, for example, may be performed by an electronic device, where the electronic device includes a processor. Details regarding the electronic device will be described in subsequent paragraphs.

Please refer to FIG. 3. In step S301, acquiring a respiratory sound.

In some implementations, the respiratory sound may be received from an input component of an electronic device (e.g., a microphone, stethoscope, etc.). However, the present disclosure is not limited to the source of the respiratory sound(s).

Please refer to FIG. 3. In step S303, classifying the respiratory sound into one of a plurality of respiratory sound categories based on a machine learning model.

Specifically, the aforementioned machine learning model is trained based on a dataset, which is expanded using the data augmentation method illustrated in FIG. 1.

In some implementations, the plurality of respiratory sound categories may include a crackle category and a wheeze category. In some implementations, the plurality of respiratory sound categories may further include two categories, such as both crackle and wheeze occurring simultaneously, as well as normal sounds.

In some implementations, the machine learning model may include a convolutional neural network (CNN) model. For example, the machine learning model may include a CNN model pre-trained on an audio dataset, the audio dataset may be Google™s AudioSet dataset.

Table 1 illustrates models' performances under various classification methods. The models were trained using datasets that had been augmented with different data augmentation methods. The dataset, for example, may be the one provided by the 2017 International Conference on Biomedical and Health Informatics (ICBHI).

TABLE 1

| | | Model | | sensitivity | specificity | ICBHI |
|---|---|---|---|---|---|---|
| Split | Method | Architecture | Augmentation | (%) | (%) | score(%) |
| 60-40 | Cotuning | ResNet | — | 37.24 | 79.34 | 58.29 |
| | RespireNet | ResNet34 | Concat, Clip | 40.10 | 72.30 | 56.20 |
| | Domain Transfer | ResNeSt | Domain | 40.20 | 70.40 | 55.30 |
| | ARSC-Net | bi-ResNet-Att | Audio, Mixup | 46.38 | 67.13 | 56.76 |
| | Metadata | CNN6 | SpecAug | 39.15 | 75.95 | 57.55 |
| | Patch-Mix CL | AST | Patch-Mix | 43.07 | 81.66 | 62.37 |
| | Ours | CNN14 | GaP-aug, Mixup | 58.20 | 77.07 | 67.64 |
| 80-20 | RespireNet | ResNet34 | Concat, Clip | 53.70 | 83.30 | 68.50 |
| | LSTM-S7 | RNN | Overlap | 62.00 | 85.00 | 74.00 |
| | MBTCNSE | TCN | Overlap | 65.30 | 86.10 | 75.70 |
| | Multi-feature | CNN | Audio | 67.22 | 82.87 | 75.04 |
| | Contrastive | CNN | Audio | 70.93 | 85.44 | 78.18 |
| | Embed | | | | | |
| | AudioSet | CNN | — | 43.38 | 83.93 | 63.66 |
| | pretrained | | | | | |
| | Ours | CNN14 | GaP-aug, Mixup | 74.62 | 86.13 | 80.37 |

The dataset provided by the ICBHI in 2017 includes a total of 6,898 respiratory sound samples. These respiratory sounds may be classified into four types. The four types of respiratory sounds include: respiratory sounds with abnormal crackle, respiratory sounds with abnormal wheeze, respiratory sounds with both abnormal crackle and wheeze, and normal sounds (Normal) without any abnormal respiratory sounds. Among these, the proportion of normal sounds (Normal) without abnormal respiratory sounds accounts for more than half of the entire dataset.

In Table 1, “60-40” refers to splitting the official dataset into a 60:40 ratio, where 60% of the dataset is used as the training set and 40% is used as the test set. “80-20” refers to first splitting the dataset into an 80:20 ratio, with 80% of the dataset is used as the training set and 20% is used as the test set, followed by performing 5-fold cross-validation on the training set. Sensitivity may be defined as the recall rate for abnormal respiratory sounds, while specificity represents the recall rate for normal sounds (Normal). The ICBHI score is calculated as the average of sensitivity and specificity.

In Table 1, Cotuning refers to the method described in the paper titled “Lung sound classification using co-tuning and stochastic normalization” by T. Nguyen and F. Pernkopf, published in 2022; RespireNet refers to the method described in the paper titled “RespireNet: A deep neural network for accurately detecting abnormal lung sounds in limited data setting” by S. Gairola, F. Tom, N. Kwatra, and M. Jain, published in 2021; Domain Transfer refers to the method described in the paper titled “A domain transfer based data augmentation method for automated respiratory classification” by Z. Wang and Z. Wang, published in 2022; ARSC-Net refers to the method described in the paper titled “ARSC-Net: Adventitious respiratory sound classification network using parallel paths with channel-spatial attention” by L. Xu, J. Cheng, J. Liu, H. Kuang, F. Wu, and J. Wang, published in 2021; Metadata refers to the method described in the paper titled “Pretraining respiratory sound representations using metadata and contrastive learning” by I. Moummad and N. Farrugia, published in 2023; Patch-Mix CL refers to the method described in the paper titled “Patch-Mix Contrastive Learning with Audio Spectrogram Transformer on Respiratory Sound Classification” by S. Bae, J.-W. Kim, W.-Y. Cho, H. Baek, S. Son, B. Lee, C. Ha, K. Tae, S. Kim, and S.-Y. Yun, published in 2023; LSTM-S7 refers to the method described in the paper titled “Deep auscultation: Predicting respiratory anomalies and diseases via recurrent neural networks” by D. Perna and A. Tagarelli, published in 2019; MBTCNSE refers to the method described in the paper titled “Automatic respiratory sound classification via multi-branch temporal convolutional network” by Z. Zhao, Z. Gong, M. Niu, J. Ma, H. Wang, Z. Zhang, and Y. Li, published in 2022; Multi-feature refers to the method described in the paper titled “Multispectral feature extraction to improve lung sound classification using CNN” by D. Kumar et al., published in 2023; Contrastive Embed refers to the method described in the paper titled “Contrastive embedding learning method for respiratory sound classification” by W. Song, J. Han, and H. Song, published in 2021; AudioSet pretrained refers to the method described in the paper titled “PANNs: Large-scale pretrained audio neural networks for audio pattern recognition” by Q. Kong, Y. Cao, T. Iqbal, Y. Wang, W. Wang, and M. D. Plumbley, published in 2020. Lastly, Ours refers to the respiratory sound classification method proposed in the implementations of the present disclosure.

Please refer to Table 1. In the 60-40 data split, the method with the best sensitivity is ARSC-Net, achieving a sensitivity of 46.38%. The sensitivity of the respiratory sound classification method in the implementations of the present disclosure is 58.20%. Accordingly, the sensitivity of the respiratory sound classification method in the implementations of the present disclosure demonstrates an improvement of 11.82% compared to the sensitivity of the ARSC-Net method.

Please continue to refer to Table 1. The method with the best ICBHI score is Patch-Mix CL, achieving an ICBHI score of 62.37%. The ICBHI score of the respiratory sound classification method in the present disclosure is 67.64%. Accordingly, the ICBHI score of the respiratory sound classification method in the present disclosure demonstrates an improvement of 5.27% compared to the ICBHI score of the Patch-Mix CL method in the prior art.

Please refer to Table 1. In the 80-20 data split, the method with the best sensitivity in the prior art is Contrastive Embed, achieving a sensitivity of 70.93%. The sensitivity of the respiratory sound classification method in the present disclosure is 74.62%. Accordingly, the sensitivity of the respiratory sound classification method in the present disclosure demonstrates an improvement of 3.69% compared to the sensitivity of the Contrastive Embed method in the prior art. Furthermore, the method with the best specificity is MBTCNSE, achieving a specificity of 86.10%. The specificity of the respiratory sound classification method in the present disclosure is 86.13%. Accordingly, the specificity of the respiratory sound classification method in the present disclosure is almost identical to the specificity of the Contrastive Embed method in the prior art.

Please refer to Table 1. Among the current prior arts, the method with the best ICBHI score is Contrastive Embed, achieving an ICBHI score of 78.18%. The ICBHI score of the respiratory sound classification method in the present disclosure is 80.37%. Accordingly, the ICBHI score of the respiratory sound classification method in the present disclosure demonstrates an improvement of 2.19% compared to the ICBHI score of the Contrastive Embed method in the prior art.

Table 2 illustrates the performance of models trained using different data augmentation methods under the same model architecture.

TABLE 2

| Data augmentation | sensitivity % | specificity % | ICBIH score(%) |
|---|---|---|---|
| Naïve | 48.34 | 64.28 | 56.31 |
| Noise | 50.21 | 62.06 | 56.14 |
| Speed, loudness, shift | 47.83 | 64.28 | 56.06 |
| Concat + Blank | 54.46 | 78.53 | 66.50 |
| Mixup | 55.88 | 71.82 | 63.85 |
| SpecAug w/o Mixup | 50.89 | 77.96 | 64.43 |
| PatchMask w/o Mixup | 54.88 | 76.18 | 65.53 |
| GaP-aug w/o Mixup | 56.49 | 76.94 | 66.72 |
| SpecAug w/ Mixup | 48.63 | 79.54 | 64.09 |
| PatchMask w/ Mixup | 54.88 | 77.01 | 65.94 |
| GaP-aug w/ Mixup | 58.20 | 77.07 | 67.64 |

In Table 2, the CNN14 model is primarily used for training, utilizing the official dataset split at a 60:40 ratio, where 60% of the dataset serves as the training set, and 40% serves as the testing set. Sensitivity is defined as the recall rate for abnormal respiratory sounds. Specificity is defined as the recall rate for normal sounds (Normal). The ICBHI score is calculated as the average of sensitivity and specificity.

In Table 2, Naïve refers to the method described in “PANNs: Large-scale pretrained audio neural networks for audio pattern recognition,” published in 2020 by Q. Kong, Y. Cao, T. Iqbal, Y. Wang, W. Wang, and M. D. Plumbley; Concat+Blank refers to the method described in “It takes two to tango: Mixup for deep metric learning,” published in 2022 by S. Venkataramanan, B. Psomas, E. Kijak, L. Amsaleg, K. Karantzalos, and Y. Avrithis. Mixup refers to the method described in “mixup: Beyond empirical risk minimization, “published in the International Conference on Learning Representations in 2018 by H. Zhang, M. Cisse, Y. N. Dauphin, and D. Lopez-Paz. Additionally, GaP-aug represents the data augmentation method proposed in the implementations of the present disclosure.

Please refer to Table 2. The Naïve method, which does not involve any data augmentation, has a sensitivity of 48.34%. The Mixup method achieves a sensitivity of 55.88%. The data augmentation method proposed in the present disclosure (GaP-aug w/Mixup) achieves a sensitivity of 58.20%. Accordingly, the sensitivity of the data augmentation method (GaP-aug w/Mixup) proposed in the present disclosure is improved by 9.86% compared to the Naïve method, and by 2.32% compared to the sensitivity of the Mixup method from the prior art.

Please refer to Table 2. In the prior art, the Naïve method achieves an ICBHI score of 56.31%. The data augmentation method proposed in the present disclosure (GaP-aug w/Mixup) achieves an ICBHI score of 67.64%. Accordingly, the ICBHI score of the data augmentation method (GaP-aug w/Mixup) proposed in the present disclosure is improved by 11.33% compared to the Naïve method. Furthermore, the ICBHI score of the proposed method (GaP-aug w/Mixup) in the present disclosure is superior to all the other data augmentation methods in the prior art. Therefore, the data augmentation method (GaP-aug w/Mixup) proposed in the present disclosure outperforms the methods listed in Table 2 in terms of both sensitivity and ICBHI score.

### <<Visualization Verification>>

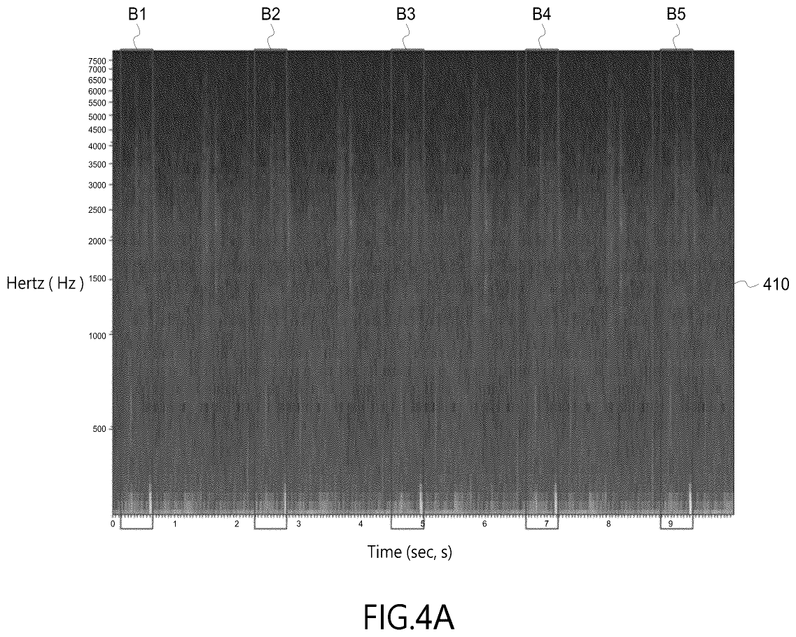

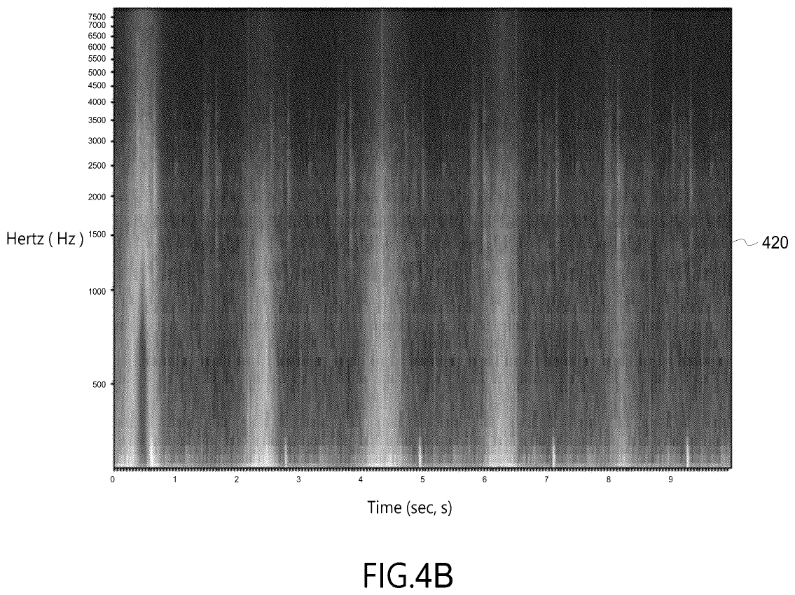

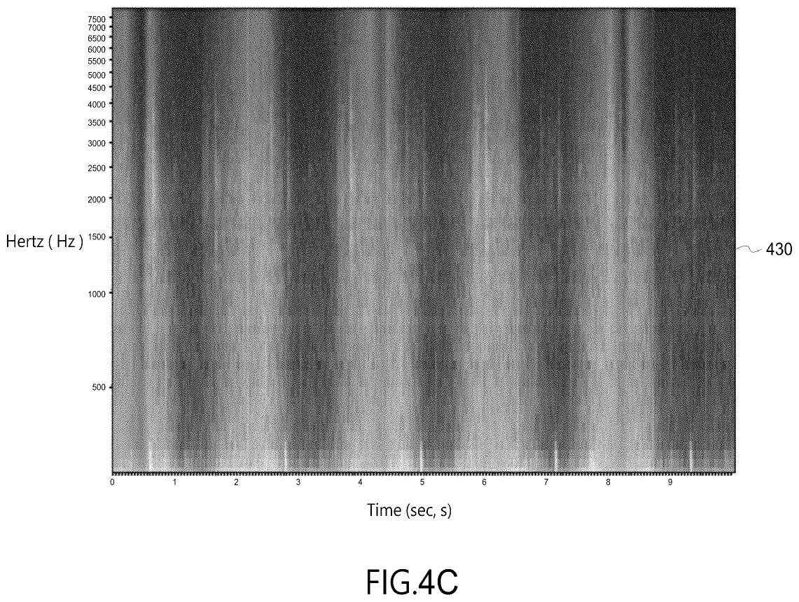

FIG. 4A is a first spectrogram according to an example implementation of the present disclosure.

Please refer to FIG. 4A. The first spectrogram 410 represents a spectrogram with both crackle and wheeze features. In the first spectrogram 410, there are a total of five complete breathing cycles (B1, B2, B3, B4, B5, each representing a complete breathing cycle), where each breathing cycle containing both crackle and wheeze features.

FIG. 4B illustrates an overlay of a first heatmap and a first spectrogram according to an example implementation of the present disclosure.

Please refer to FIG. 4B. The first heatmap is a heatmap showing the features that are captured by the model from the first spectrogram 410, where the model is trained on the dataset that is augmented using the SpecAug method. The first heatmap is overlaid with the first spectrogram 410 to form the first overlay 420. The horizontal axis of the first overlay 420 represents time, and the vertical axis of the first overlay 420 represents frequency, with frequency increasing upward from the bottom to the top of the first overlay 420.

In some implementations, the first heatmap is generated using the Gradient Class Activation Mapping (Grad-CAM) method.

Specifically, the processor uses Grad-CAM to generate a visual heatmap that highlights the regions of the image on which the model focuses. For example, when using a model (e.g., CNN14 model) for respiratory sound classification, the processor may apply Grad-CAM to the last convolutional layer of the model, thus obtaining a heatmap of the regions that the model attends to for classification, which allows the training progress of the model to be inspected via Grad-CAM.

Please continue to refer to FIG. 4B. SpecAug is a method described in “SpecAugment: A Simple Data Augmentation Method for Automatic Speech Recognition” by D. S. Park, W. Chan, Y. Zhang, C.-C. Chiu, B. Zoph, E. D. Cubuk, and Q. V. Le, published in 2019.

Please refer to FIG. 4B. The first heatmap illustrates the results of the model capturing features from the first spectrogram 410, the results are visualized in the heatmap generated through Grad-CAM. From the first overlay 420, it may be observed that the features captured by the model from the first spectrogram 410 in the region of relatively low frequencies (e.g., below 2000 Hz). As mentioned in previous paragraphs, these features correspond to the characteristics of crackle but do not correspond to the characteristics of wheeze.

The first spectrogram 410 represents a spectrogram with both crackle and wheeze features. It may be inferred that the dataset augmented using the SpecAug method may cause the loss of wheeze features, resulting in a decrease in the model's ability to capture wheeze features.

FIG. 4C illustrates an overlay of a second heatmap and a first spectrogram according to an example implementation of the present disclosure.

Please refer to FIG. 4C. The second heatmap is a heatmap showing the features that are captured by the model from the first spectrogram 410, where the model is trained using the dataset that is augmented by the data augmentation method proposed in the present disclosure. The second heatmap is overlaid with the first spectrogram 410 to form the second overlay 430. The horizontal axis of the second overlay represents time, and the vertical axis represents frequency, with frequency increasing upward from the bottom to the top of the second overlay 430.

In some implementations, the second heatmap is generated using the Gradient Class Activation Mapping (Grad-CAM) method.

Please continue referring to FIG. 4C. FIG. 4C illustrates the results of the model capturing features from the first spectrogram 410, the results are visualized in the heatmap that is generated through Grad-CAM. From the second overlay 430, it may be observed that the features captured by the model from the first spectrogram 410 are located in both low-frequency and high-frequency regions, covering the range from 0 to 7500 Hz. As mentioned in previous paragraphs, these features correspond to features of crackles and wheezes.

The first spectrogram 410 includes features of both crackles and wheezes, which indicates that the dataset, augmented using the data augmentation method proposed in some implementations of the present disclosure, effectively preserves the features of both crackles and wheezes, thus improving the model's ability to capture both crackles and wheezes characteristics.

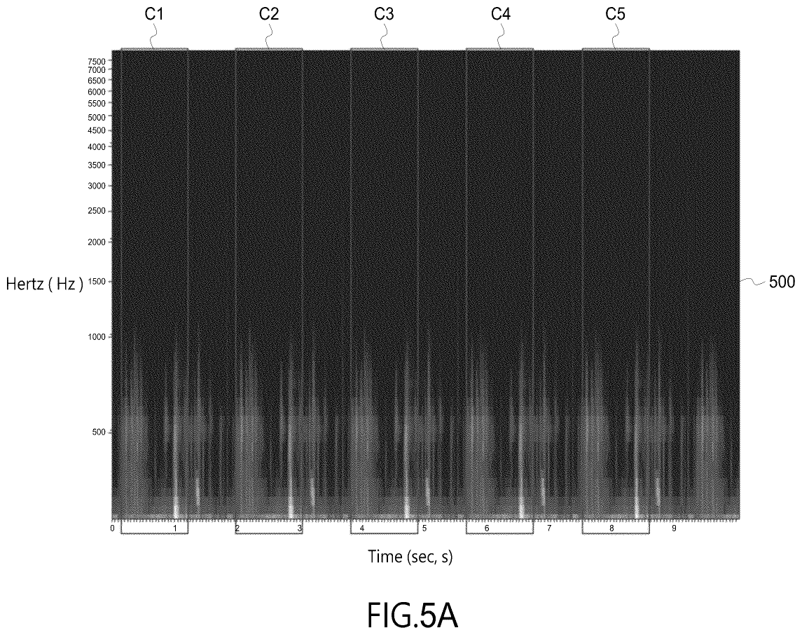

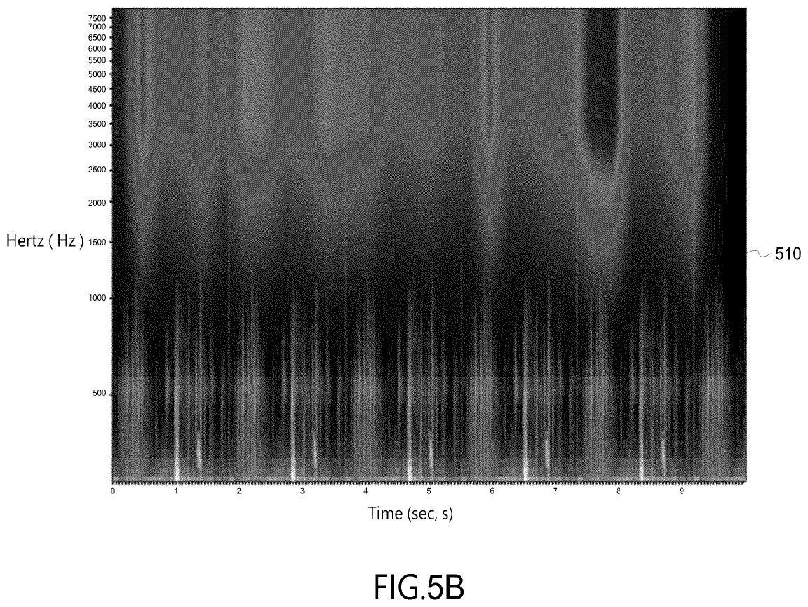

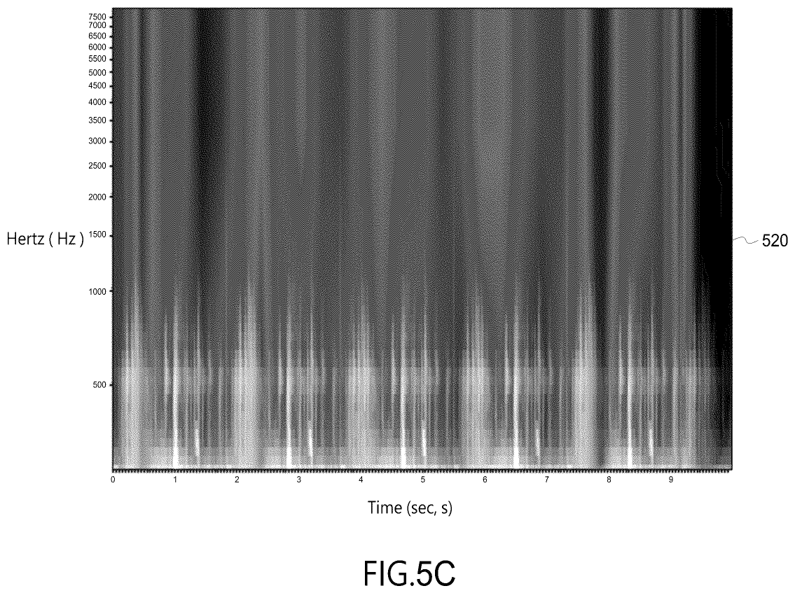

FIG. 5A is a second spectrogram according to an example implementation of the present disclosure.

Please refer to FIG. 5A. The second spectrogram 500 represents a spectrogram with crackle features. In the second spectrogram 500, there are a total of five complete breathing cycles (C1, C2, C3, C4, and C5, each representing a complete respiratory cycle), where each breathing cycle containing crackle features.

FIG. 5B illustrates an overlay of a third heatmap and a second spectrogram according to an example implementation of the present disclosure.

Please refer to FIG. 5B. The third heatmap is a heatmap showing the features that are captured by the model from the second spectrogram 500, where the model is trained on the dataset that is augmented using the SpecAug method. The third heatmap is overlaid with the second spectrogram 500 to form the third overlay 510. The horizontal axis of the third overlay 510 represents time, and the vertical axis represents frequency, with frequency increasing upward from the bottom to the top of the third overlay 510.

In some implementations, the third heatmap is generated using the Gradient Class Activation Mapping (Grad-CAM) method.

Please refer to FIG. 5B. SpecAug is a method described in “SpecAugment: A Simple Data Augmentation Method for Automatic Speech Recognition” by D. S. Park, W. Chan, Y. Zhang, C.-C. Chiu, B. Zoph, E. D. Cubuk, and Q. V. Le, published in 2019.

Please continue referring to FIG. 5B. The third heatmap visualized the results of the model capturing features from the second spectrogram 500, the results are visualized in the heatmap that is generated through Grad-CAM. From the third overlay 510, it may be observed that the features captured by the model from the second spectrogram 500 are located in the relatively high-frequency regions of the second spectrogram 500 (e.g., within the range of 3000 to 7500 Hz). As mentioned in previous paragraphs, these features correspond to the characteristics of wheeze but not to the characteristics of crackle.

The second spectrogram 500 represents a spectrogram with crackle features. This indicates that the dataset augmented using the SpecAug method may result in the loss of crackle features, thus reducing the model's ability to capture crackle features effectively.

FIG. 5C illustrates an overlay of a fourth heatmap and a second spectrogram according to an example implementation of the present disclosure.

Please refer to FIG. 5C. The fourth heatmap is a heatmap showing the features that are captured by the model from the second spectrogram 500, where the model is trained using a dataset that is augmented by the data augmentation method proposed in the present disclosure. The fourth heatmap is overlaid with the second spectrogram 500 to form the fourth overlay 520. The horizontal axis of the fourth overlay 520 represents time, and the vertical axis represents frequency, with frequency increasing upward from the bottom to the top of the fourth overlay 520.

In some implementations, the fourth heatmap is generated using the Gradient Class Activation Mapping (Grad-CAM) method.

Please continue referring to FIG. 5C. FIG. 5C shows the results of the model capturing features from the second spectrogram 500, the results are presented in the heatmap that is generated through Grad-CAM. From the fourth overlay 520, it may be observed that the features captured by the model from the second spectrogram 500 are located in the relatively low-frequency region (e.g., 0 to 2000 Hz). As mentioned in previous paragraphs, these features correspond to the characteristics of crackles.

The second spectrogram 500 includes features of crackles, which indicates that the dataset, augmented using the data augmentation method proposed in some implementations of the present disclosure, effectively preserves the features of crackles, thus improving the model's ability to capture the features of crackles.

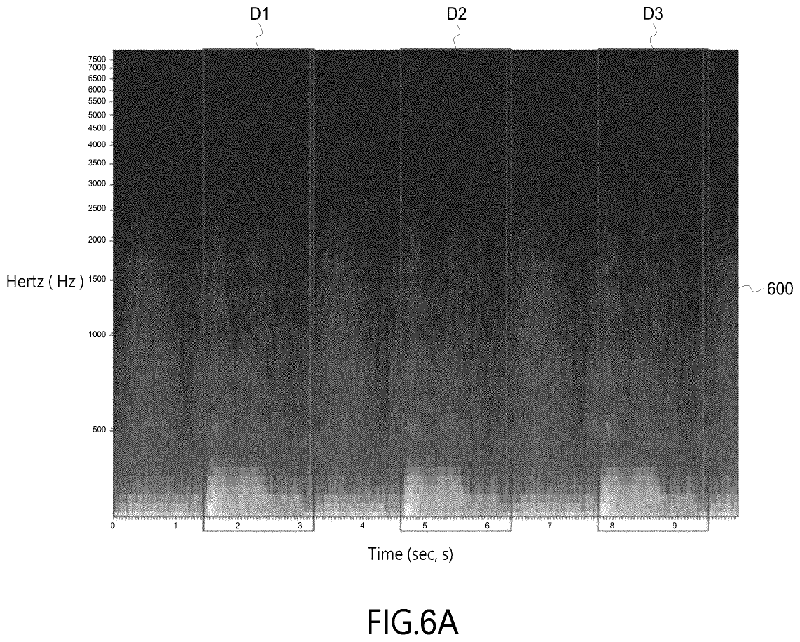

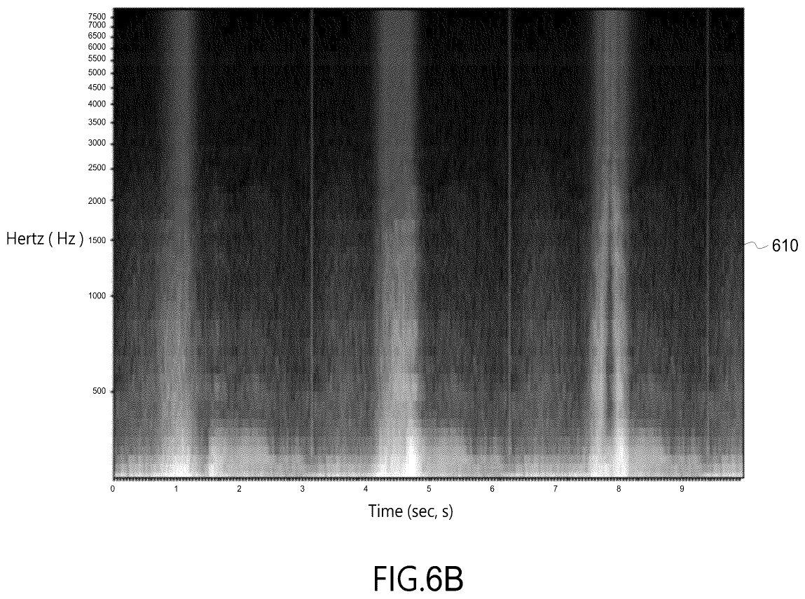

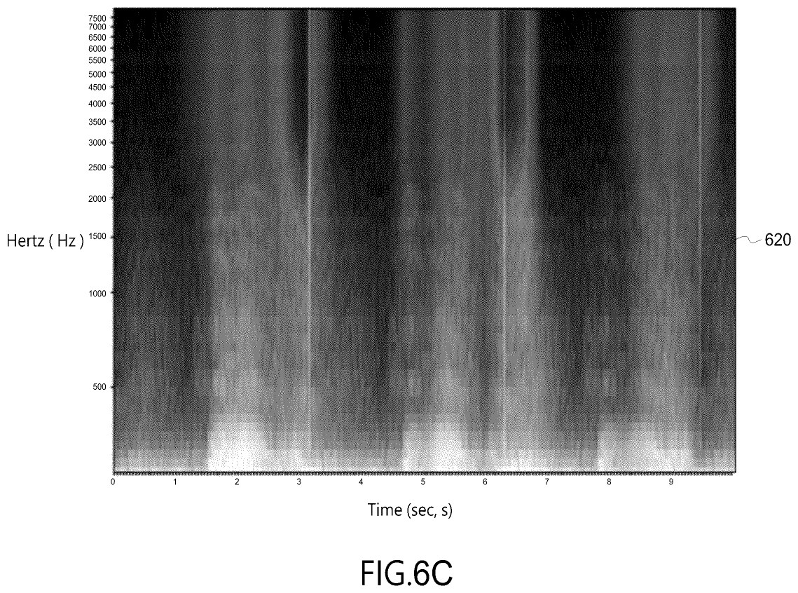

FIG. 6A is a third spectrogram according to an example implementation of the present disclosure.

Please refer to FIG. 6A. The third spectrogram 600 represents a spectrogram with wheeze features. In the third spectrogram 600, there are a total of three complete breathing cycles (D1, D2, and D3, each representing a complete breathing cycle), where each complete breathing cycle contains wheeze features.

FIG. 6B illustrates an overlay of a fifth heatmap and a third spectrogram according to an example implementation of the present disclosure.

Please refer to FIG. 6B. The fifth heatmap is a heatmap showing the features that are captured by the model from the third spectrogram 600, where the model is trained on the dataset that is augmented with the SpecAug method. The fifth heatmap is overlaid with the third spectrogram 600 to form the fifth overlay 610. The horizontal axis of the fifth overlay represents time, and the vertical axis of the fifth overlay represents frequency, with frequency increasing upward from the bottom of the fifth overlay 610.

Please refer to FIG. 6B. SpecAug is a method described in “SpecAugment: A Simple Data Augmentation Method for Automatic Speech Recognition” by D. S. Park, W. Chan, Y. Zhang, C.-C. Chiu, B. Zoph, E. D. Cubuk, and Q. V. Le, published in 2019.

Referring to FIG. 6B, the fifth heatmap illustrates the result of the model capturing features from the third spectrogram 600, the results are visualized in the heatmap generated through Grad-CAM. From the fifth overlay 610, it may be observed that the features captured by the model are concentrated in relatively low-frequency regions of the third spectrogram 600 (e.g., between 0 and 2000 Hz).

The third spectrogram 600 represents a spectrogram with wheeze features. This indicates that the dataset augmented using the SpecAug method may cause the loss of the wheeze features, thus reducing the model's ability to capture wheeze features effectively.

FIG. 6C illustrates an overlay of a sixth heatmap and a third spectrogram according to an example implementation of the present disclosure.

Please refer to FIG. 6C. The sixth heatmap is a heatmap showing the features that are captured by the model from the third spectrogram 600, where the model is trained using a dataset that is augmented by the data augmentation method proposed in the present disclosure. The sixth heatmap is overlaid with the third spectrogram 600 to form the sixth overlay 620. The horizontal axis of the sixth overlay 620 represents time, and the vertical axis of the sixth overlay 620 represents frequency, with the frequency increasing upward from the bottom to the top of the sixth overlay 620.

In some implementations, the sixth heatmap is generated using the Gradient Class Activation Mapping (Grad-CAM) method.

Please continue to refer to FIG. 6C. FIG. 6C illustrates the results of the model capturing features from the third spectrogram 600, the results are visualized in the heatmap generated through Grad-CAM. From the sixth overlay 620, it may be observed that the features captured by the model from the third spectrogram 600 are located in the relatively higher frequency region (e.g., 2000 to 7500 Hz), corresponding to the features of wheezes.

The third spectrogram 600 includes features of wheezes, which indicates that the dataset, augmented using the data augmentation method proposed in some implementations of the present disclosure, effectively preserves the features of wheezes, thus improving the model's ability to capture the features of wheezes.

The above-mentioned results show that when using the dataset augmented with the data augmentation method from the implementations of the present disclosure to train the model, the unique features of the wheezes and crackles categories in the spectrogram may be preserved. However, when using the dataset augmented with the SpecAug method from the prior art to train the model, the model tends to select features from non-wheezes and non-crackles categories as the basis for determining the wheezes and crackles categories. This is because the dataset augmented with the SpecAug method may cause the wheezes and crackles features to be randomly masked, leading to misleading judgment of abnormal breathing sound features during model training.

Therefore, the dataset generated by the SpecAug method causes a certain degree of misguidance during the model training process. However, when training the model with the dataset generated by the data augmentation method proposed in some implementations of the present disclosure, the model correctly selects features of wheezes and crackles in the spectrogram as the basis for determining wheezes and crackles. Furthermore, as mentioned in previous paragraphs, these features may be correctly mapped to the characteristics of wheezes and crackles.

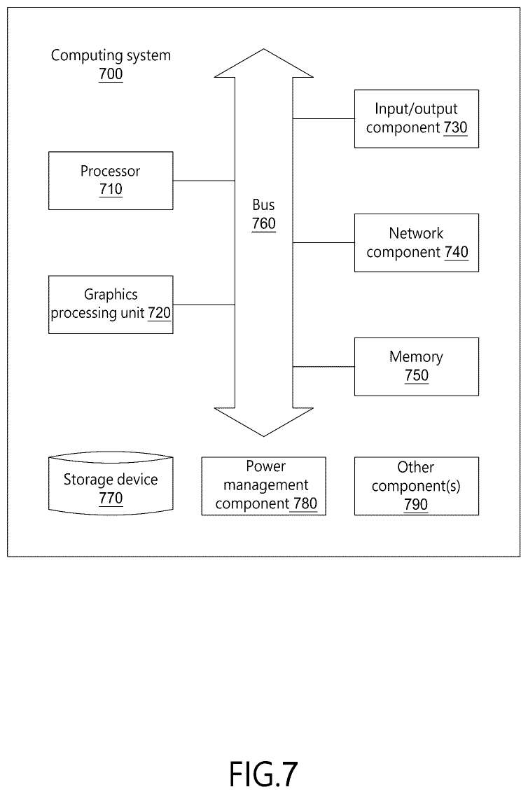

FIG. 7 is a block diagram of a computing system according to an example implementation of the present disclosure.

Please refer to FIG. 7. The computing system 700 may be implemented as a system that implements data augmentation method or respiratory sound classification method. In some implementations, the computing system 700 may be implemented in the form of an electronic device, which may include, but is not limited to, one or more of the following components: processor (e.g., Central Processing Unit (CPU)) 710, Graphics Processing Unit (GPU) 720, input/output components 730, network components 740, and memory 750. These components may communicate and transfer data via the system bus 760. However, the present disclosure does not limit the specific models, quantities, and configurations of these components. Those skilled in the art can adjust, select, or add/subtract components based on the specific requirements and operating environment when implementation.

In some implementations, the primary computing core inside the computing system 700 is one or more processors 710. This processor 710 may be responsible for running the main computational processes and related control logic of algorithms such as deep learning. In some implementations, the processor 710 may be configured to execute processing instructions (e.g., machine/computer-executable instructions) stored in non-volatile computer-readable media (e.g., storage device 770).

In some implementations, to enhance the computational efficiency of deep learning, the computing system 700 may also include one or more graphics processing unis 720 designed for massive parallel computations. The graphics processing unit 720 may effectively improve the system's computational capacity during deep learning training and inference.

In some implementations, the computing system 700 may include various input/output components 730 configured to receive user input and display system output. For example, the input/output components 730 may include a keyboard, mouse, touchpad, display screen, speakers, and other types of sensing devices.

In some implementations, the computing system 700 may also include network components 740 configured for network communication. For example, the network component 740 may include a network interface card for wired or wireless network connections, or communication modules for 3G, 4G, 5G, or other wireless communication technologies.

In some implementations, the computing system 700 may include one or more memory components 750, such as volatile memory components like Random Access Memory (RAM). The memory 750 may store the parameters of the deep learning model, as well as other data and programs used to run algorithms like deep learning. In some implementations, memory 750 stores multiple feature extractors.

Furthermore, the computing system 700 may also include one or more of the following components: storage devices 770, power management components 780, and other various hardware components 790.

In some implementations, the computing system 700 may include one or more storage devices 770, such as non-volatile memory components like Hard Disk Drive (HDD) or Solid State Drive (SSD). The storage devices 770 may be configured to store the code of deep learning software, training data, model parameters, etc. Additionally, storage devices 770 may also be configured to store intermediate results and final outputs of algorithms like deep learning.

In some implementations, the computing system 700 may include one or more power management components 780, configured to provide power to various hardware components of the computing system 700 and manage their power consumption. This power management component 780 may include batteries, power converters, and other power management devices.

In some implementations, the computing system 700 may also include other various hardware components 790, such as cooling fans, heat dissipators, and other various control and monitoring devices. The present disclosure is not limited in this regard.

Additionally, implementations of the present disclosure may also be implemented as one or more computer program products or one or more non-transitory computer-readable medium, which include one or more instructions of a computer program. Specifically, the computer program (also referred to as a program, software, script, or code) may be presented in any form of programming language and can be deployed in any form. During the operation of the computing system 700 (e.g., electronic device), the instructions or part of them may reside entirely or at least partially inside the processor 710, allowing the processor 710 to execute the methods introduced in the disclosure.

In summary, the data augmentation method, respiratory sound classification method, and electronic device proposed in implementations of the present disclosure address the challenge of insufficient data for abnormal respiratory sounds. Additionally, preserving the features of abnormal respiratory sounds during the data augmentation process, thus enhancing the neural network's sensitivity and specificity in distinguishing abnormal respiratory sounds.

The embodiments shown and described above and below are only examples. Many details are often found in the art. Therefore, many such details are neither shown nor described herein for the sake of brevity. Even though numerous characteristics and advantages of the present disclosure have been set forth in the foregoing description, together with details of the structure and function of the present disclosure, the present disclosure is illustrative only, and changes may be made in the details. It will therefore be appreciated that the embodiments described above and below may be modified within the scope of the claims.

What is claimed is:

1. A data augmentation method for expanding a dataset comprising a plurality of spectrograms, the data augmentation method comprising:
selecting at least one patch within a first spectrogram of the plurality of spectrograms;
determining at least one adjustment value corresponding to the at least one patch within the first spectrogram; and
adjusting the at least one patch within the first spectrogram, based on the at least one adjustment value, to obtain a first adjusted spectrogram, wherein the at least one adjustment value comprises at least one of a contrast adjustment value, a brightness adjustment value, and a gamma adjustment value.

2. The data augmentation method of claim 1, wherein determining the at least one adjustment value corresponding to the at least one patch within the first spectrogram comprises:
determining the at least one adjustment value within a predefined range for each of the at least one patch.

3. The data augmentation method of claim 2, wherein determining the at least one adjustment value within the predefined range for each of the at least one patch comprises:
determining a gamma adjustment value within the predefined range, wherein a minimum value of the gamma adjustment value is greater than or equal to 1.

4. The data augmentation method of claim 1, further comprising:
synthesizing the first adjusted spectrogram and a second spectrogram in the dataset, based on a synthesis ratio, to obtain a synthesized spectrogram.

5. The data augmentation method of claim 4, wherein both of the first spectrogram and the first adjusted spectrogram correspond to a first label, the second spectrogram corresponds to a second label, and the data augmentation method further comprises:
determining a third label corresponding to the synthesized spectrogram based on the first label, the second label, and the synthesis ratio.

6. The data augmentation method of claim 1, wherein a width of each of the at least one patch is smaller than a width of the first spectrogram.

7. The data augmentation method of claim 1, wherein each of the plurality of spectrograms comprises a Mel spectrogram.

8. A respiratory sound classification method, comprising:
acquiring a respiratory sound; and
classifying the respiratory sound into one of a plurality of respiratory sound categories based on a machine learning model, wherein the machine learning model is trained based on a dataset, and the dataset is expanded based on the data augmentation method of claim 1.

9. The respiratory sound classification method of claim 8, wherein the plurality of respiratory sound categories comprises a crackle category and a wheeze category.

10. The respiratory sound classification method of claim 8, wherein the machine learning model comprises a convolutional neural network (CNN) model.

11. An electronic device, comprising:
a memory storing at least one computer-executable instruction; and
a processor coupled to the memory and configured to execute the at least one computer-executable instruction to perform the data augmentation method of claim 1.
